(19) United States
(12) Patent Application Publication
(10) Pub. No.: US 2020/0306567 A1
(43) Pub. Date: Oct. 1, 2020

(54) Programmable Accountability Alert System

(71) Applicant: SCOTT TECHNOLOGIES, INC., Monroe, NC (US)

(72) Inventor: Ryan Alan WALLACE, Matthews, NC (US)

(73) Assignee: Scott Technologies, Inc., Monroe, NC (US)

(21) Appl. No.: 16/088,167

(22) PCT Filed: Apr. 6, 2017
(86) PCT No.: PCT/US17/26333

§ 371 Date: Sep. 25, 2018

Related U.S. Application Data
(60) Provisional application No. 62/319,594, filed on Apr. 7, 2016.

(51) Int. Cl. A62B 9/00; A62B 18/02; A62B 18/08; G08B 6/00; G08B 25/01; G01C 19/00; G01P 15/00

(52) U.S. Cl. CPC A62B 9/006; A62B 18/025; A62B 18/02; G01P 15/00; G08B 6/00; G08B 25/016; G01C 19/00; A62B 18/08

(57) ABSTRACT

A method and system for communication with a user. The system includes a respirator including a facemask. At least one haptic device is disposed on the facemask. The at least one haptic device is configured to provide tactile stimulation to at least a portion of the facemask.

### TECHNICAL FIELD

The present invention relates to a method and system using programmable tactile outputs to communicate with a user.

### BACKGROUND

Immediately dangerous to life or health (IDLH) environments are conditions encountered by first responders, such as firemen, law enforcement, military personnel, and personnel treating chemical or toxic waste conditions or emergencies, warranting the use of personal protection equipment and/or respiratory protection. Examples of conditions often encountered by IDLH first responders include smoke or other poisonous gases at sufficiently high concentrations that warrant the use of turnout gear, such as a respirator and/or a self-contained breathing apparatus (SCBA) and a full body protective suit. IDLH conditions often further include fire and other loud noises, which combined with the turnout gear, decrease visibility and the ability of the first responder to navigate by sound or search for distressed or injured people.

Current systems to communicate with first responders are audio based. That is, people remote from IDLH environments communicate orally with first responders via radio, such as a hand held two-way radio receiver or mobile phone. The first responder may have an earpiece in communication with the mobile to listen to remote instructions. However, it may be difficult for a first responder to hear instructions. Moreover, gases, fire, and other visual impairments may prevent the first responder from navigation by visual cues.

### SUMMARY

The present disclosure advantageously provides a method and system for tactile-based communication with a user. The system includes a respirator including a facemask. At least one haptic device is disposed on the facemask. The at least one haptic device is configured to provide tactile stimulation to at least a portion of the facemask.

In another aspect of this embodiment, the facemask is a half mask sized to fit over a user's mouth and nose, and the at least one haptic device includes two haptic actuators, and the two haptic actuators are disposed on opposite sides of the half mask. In another aspect of this embodiment, the facemask is a full mask sized to be pressed against a perimeter of a user's face, and the at least haptic device includes two haptic actuators, and the two haptic actuators are disposed on opposite sides of the full mask.

In another aspect of this embodiment, the at least one haptic device includes at least one haptic actuator, the at least one haptic actuator is configured to provide tactile stimulation to at least the portion of the facemask. A receiver is configured to wirelessly receive information from a remote communications device. A processor in communication with the receiver is included, the processor is configured to process the received information to create an actuator driving signal for a determined at least one of the at least one haptic actuators and transmit the at least one actuator driving signal to the determined at one haptic actuator. In another aspect of this embodiment, the received information includes at least one of guidance information, a change in ambient conditions, and a verbal communication attempt. In another aspect of this embodiment, the tactile simulation includes at least one vibration.

In another aspect of this embodiment, the at least one haptic device further includes a transmitter configured to wirelessly transmit information of at least one of a position and orientation of the facemask and an emergency request for assistance. In another aspect of this embodiment, the haptic device further includes at least one of an accelerometer and a gyroscope. In another aspect of this embodiment, the at least one haptic device is permanently retained within the facemask. In another aspect of this embodiment, the at least one haptic device is releasably retained within the facemask.

In another embodiment, a method of communication with a user includes transmitting information to at least one haptic device from a remote communications device. The at least one haptic device is sized to be retained within a facemask of a respirator. The at least one haptic device is configured to receive the transmitted information from the remote communications device and process the information into at least one tactile output. The tactile output is imparted onto the facemask.

In another aspect of this embodiment, the transmitted information from the remote communication device includes at least one of guidance information, a change in ambient conditions, and a verbal communication attempt.

In another aspect of this embodiment, the at least one haptic device is further configured to transmit at least one of user position and orientation information to the remote communications device, and the method further includes receiving the user position and orientation information transmitted from the at least one haptic device. In another aspect of this embodiment, the facemask is a half mask sized to fit over the user's mouth and nose, and the at least one haptic device includes two haptic actuators, and the two haptic actuator are disposed on opposite sides of the half mask.

In another aspect of this embodiment, the facemask is a full mask sized to be pressed against a perimeter of the user's face, and the at least haptic device includes two haptic actuators, and the two haptic actuators are disposed on opposite sides of the full mask. In another aspect of this embodiment, the at least one haptic device includes at least one of an accelerometer and a gyroscope. In another aspect of this embodiment, the at least one haptic device is permanently retained within the facemask. In another aspect of this embodiment, the at least one haptic device is releasably retained within the facemask. In another aspect of this embodiment the at least one tactile signal includes at least one vibrating pulse.

In yet another embodiment, the system includes at least one haptic device sized to be releasably retained within a facemask of a respirator. The at least one haptic device is configured to be in wireless communication with and receive information from a remote communications device. The at least one haptic device includes a processor configured to process the information received from the remote communications device into one or more tactile signals imparted by the at least one haptic device on to the facemask when the respirator is worn. The at least one haptic device is further configured to transmit information to the remote communications device.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a rear view of an embodiment of a facemask of a respirator with at least one haptic actuator on the substrate;

FIG. 2 is a rear view of another embodiment of the respirator shown in FIG. 1 with the at least one haptic actuator separated from the substrate;

FIG. 3 is a rear view of another facemask of the respirator shown in FIG. 1 with the at least one haptic actuator on the substrate;

FIG. 4 is a rear view of another embodiment of the respirator shown in FIG. 3 with the at least one haptic actuator separated from the substrate;

FIG. 5 is a schematic of an exemplary haptic device configured to be coupled to any of the facemasks shown in FIGS. 1-4;

FIG. 6 is a schematic of another exemplary haptic device configured to be coupled to any of the facemasks shown in FIGS. 1-4;

FIG. 7 is a schematic of another exemplary haptic device configured to be coupled to any of the facemasks shown in FIGS. 1-4;

FIG. 8 is a schematic of another exemplary haptic device configured to be coupled to any of the facemasks shown in FIGS. 1-4;

FIG. 9 is a system schematic of a communication system constructed in accordance with the principles of the invention; and

FIG. 10 is a flow chart showing an exemplary method of communicating with a user performed in accordance with the principles of the present invention.

### DETAILED DESCRIPTION

As used herein, relational terms, such as “first” and “second,” “over” and “under,” “front” and “rear,” “in, within, and around” and the like, may be used solely to distinguish one entity or element from another entity or element without necessarily requiring or implying any physical or logical relationship or order between such entities or elements. The disclosure herein provides a system and method for communicating with a user via programmable tactile outputs such as may be useful when voice communication is challenging and the user's visual spectrum is limited owing to the ambient environment.

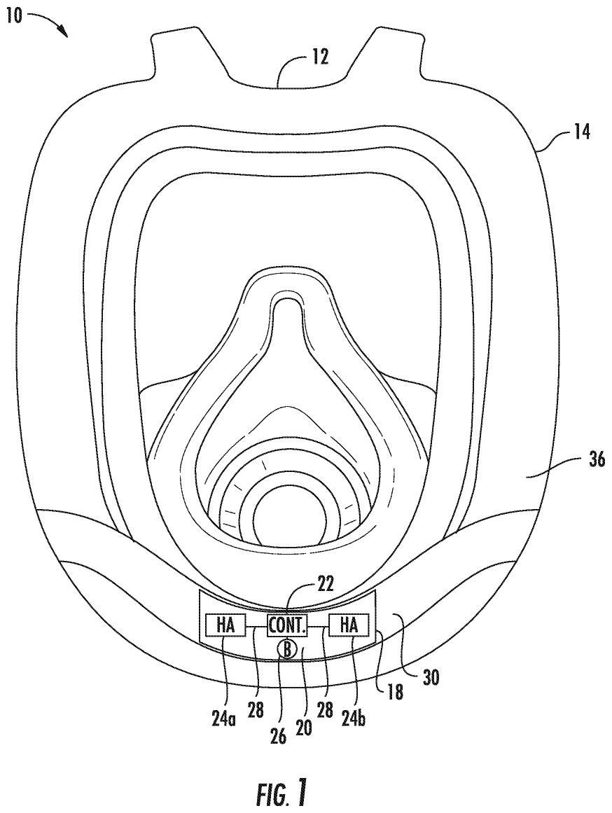

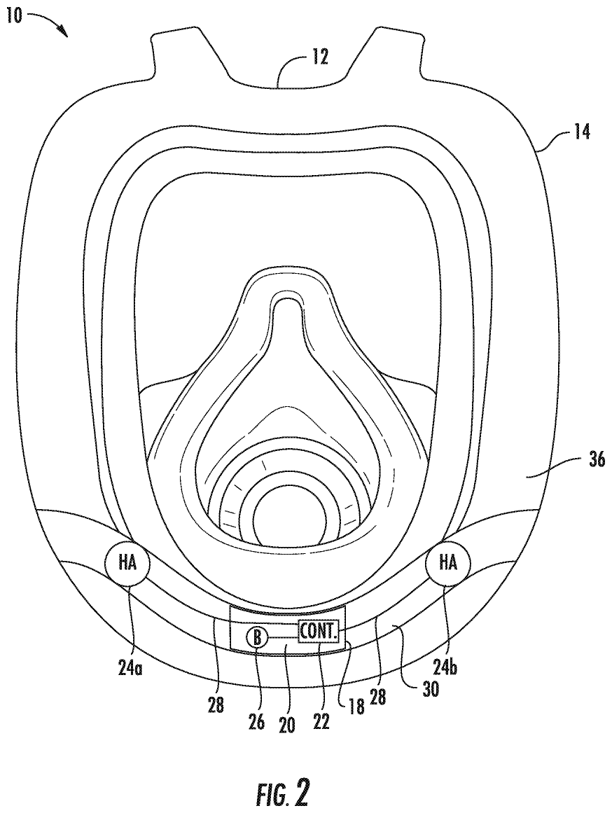

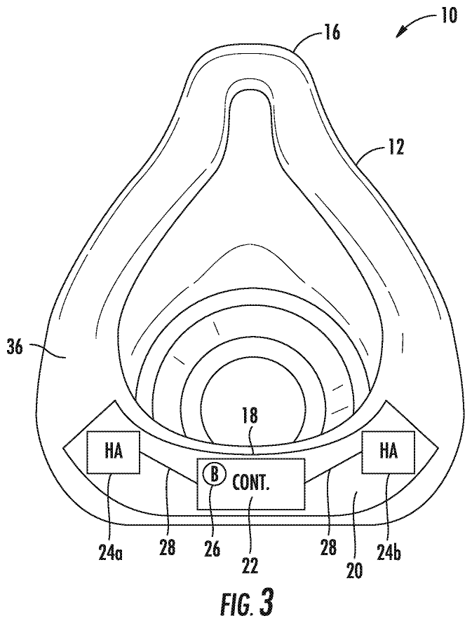

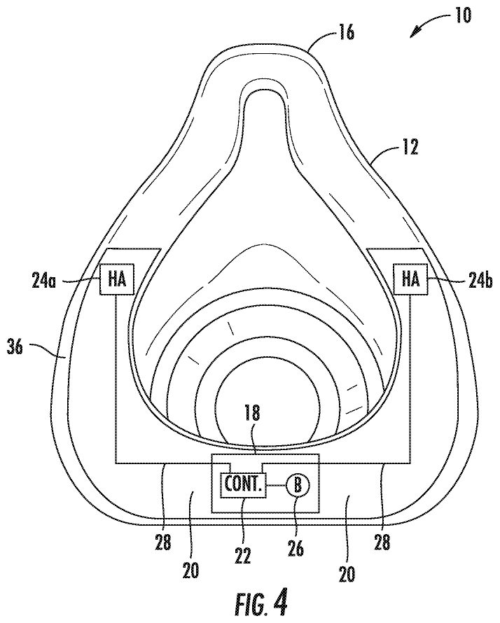

Now referring to the drawings in which like reference designators refer to like elements, there is shown in FIG. 1 a respirator constructed in accordance with the principles of the present invention and designated generally as “10.” The respirator 10 may any breathing apparatus known in the art for protecting the user form harmful environments including, but not limited to, chemicals, dusts, fumes, vapors, heat and gases. For example, the respirator 10 may include a filtering element for filtering out contaminants, or may include a dedicated air supply, such as a self-contained breathing apparatus (SCBA). The respirator 10 includes a facemask 12 sized and configured to fit and seal around the user's face. The facemask 12 may be a full mask 14, as shown in FIGS. 1-2, sized to fit around substantially the entirety of the user's face. For example, the full mask 14 may include a rubberized seal sized to be pressed against the perimeter of the user's face while providing protection for the user's eyes, nose, and mouth. In other configurations, for example as shown in FIGS. 3-4, the facemask 12 is a half mask 16, e.g., an oronasal mask, sized to be fit and pressed around only the user's mouth and nose. The facemask 12 may include a strap or other securing element that seals the facemask 12 to the user's face such that at least a portion of the facemask 12 is in contact with a portion of the user's face.

The facemask 12 may include at least one haptic device 18 sized to be received within or on a portion of the facemask 12. The haptic device 18 may be permanently retained or removably coupled to the facemask 12 with, for example, an adhesive, a fastener, or otherwise mechanically coupled to the facemask, and/or may be visible, concealed, or substantially concealed within or on any portion of the facemask 12. The haptic device 18 may include a substrate 20, a processor or other controller 22 (“Cont.”), at least one haptic actuator 24 (“HA”) and a power source 26 (“B”) such as a battery. In one embodiment, the substrate 20 includes a printed circuit board in communication with the processor or controller 22 having processing circuitry configured processes the various signals sent to and/or received from the haptic device 18. The substrate 20 may be rigid or flexible and may be permanently affixed with or to a portion of the facemask 12. Alternatively, in some embodiments the haptic device 18 may be removably insertable within the facemask 12. In the configuration shown in FIGS. 1-2, the substrate 20 is configured to contour the portion of the facemask 12 that is configured to flex and contour around the user's chin. In other embodiments, the substrate 20 may positioned within or on any portion of the facemask 12 and may be any shape or size, for example, rectangular or circular. The substrate 20 may include a pattern of electrical conductors, e.g., traces, formed or etched thereon to electrically interconnect the devices affixed thereto or electrically connected thereto such as the processor 22, the at least one haptic actuator 24, the power source 26, the receiver and the transmitter (shown in FIGS. 5-8).

The processor 22 may include embedded memory that stores a program, which when executed by the processor 22 causes the processor to describe the functions performed herein. In some embodiments, the memory is separate from the processor 22. In addition to a traditional processor 22 and memory, the processor 22 may comprise integrated circuitry for processing and/or control, e.g., one or more processors 18 and/or processor cores and/or FPGAs (Field Programmable Gate Array) and/or ASICs (Application Specific Integrated Circuitry). Processor 22 may be configured to access (e.g., write to and/or reading from) memory, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory may be configured to store code executable by processor 22 and/or other data, e.g., data pertaining to communication, e.g., configuration and/or address data of nodes, etc.

Electrically coupled to the substrate 20 may be at least one haptic actuator 24 configured to impart at least one tactile output onto the facemask 12. The haptic actuator 24 may be, in some embodiments for example, a vibrating motor and/or a force/tension feedback mechanism configured to output at least one tactile stimulation onto the facemask 12. For example, as shown in FIGS. 1, 3 and 4, haptic actuator 24a and haptic actuator 24b (collectively referred to as “haptic actuator 24”) are electrically coupled to the substrate 20 through a corresponding conductor 28, for example a wire, such that haptic actuator 24a and haptic actuator 24b extend away from the substrate 20 at a predetermined distance, and may further be coupled to, and/or retained at or within, desired positions on the facemask 12. For example, in the embodiment of FIG. 1, haptic actuator 24a and haptic actuator 24b are coupled to opposite sides of the full mask 14 proximate the chin area 30; in FIG. 3 haptic actuator 24a and haptic actuator 24b are coupled to opposite sides of the nose portion of the half mask 16; and in FIG. 4 haptic actuator 24a and haptic actuator 24b are coupled to opposite sides of the half mask 16 proximate the chin area 30. The haptic actuator(s) 24 are configured to provide tactile stimulation to a user via the facemask 12. In other configurations, the conductor 28 may be coiled within the substrate 20 such that the distance between the substrate 20 and haptic actuator 24a and/or haptic actuator 24b may be adjustable to fit to the particular facemask 12. In another embodiment, the conductor(s) 28 are entirely or partially embedded within the facemask 12 such that the haptic actuators 20 and/or the substrate 20 may be electrically slidingly adjustable within the facemask 12 while still maintaining an electrical connection. In the configuration shown in FIG. 2, haptic actuator 24a and haptic actuator 24b are mounted onto the substrate 20 and may flex with the substrate 20 to contour to the facemask 12. In some embodiments, a conductor 28 electrically couples the power source 26 to the controller 22 and/or the haptic actuator 24.

Referring now to FIG. 5 in which an exemplary haptic device 18 is shown, in communication with the processor 22 may be a transmitter 32 configured to wirelessly transmit signals from the processor 22, and a receiver 34 configured to receive wireless signals as discussed in more detail below. In some embodiments, the transmitter 32 is optional and is only needed if the haptic device 18 is arranged to transmit data to a command center or operator. The power source 26, such as a battery, may be in electrical communication with the processor 22 to provide power to the various components of the haptic device 18 and may be disposed on one side of the processor 22. In some embodiments, the power source 26 may be rechargeable. In some embodiments, the power source 26 may be a replaceable button type battery. At least one haptic device 20 may be disposed directly onto the substrate 20, e.g., on the side opposite the power source 26ry. In such a configuration, tactile outputs imparted onto the facemask 12 by the haptic actuator 24 may be perceived on a single side of the user's face.

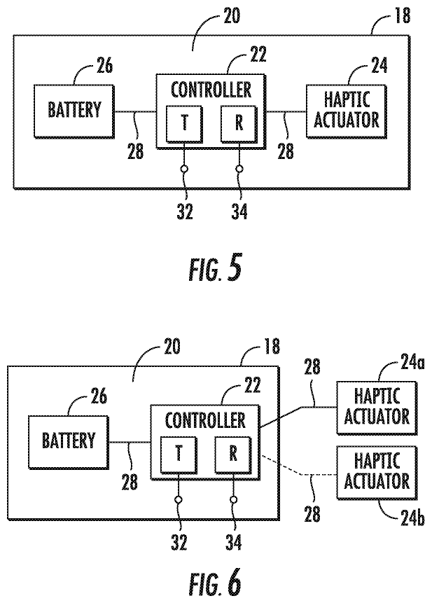

Referring now to FIG. 6, in another configuration of the haptic device 18, the power source 26 and the processor 22, along with the optional transmitter 32 and the receiver 34, may be mounted onto the substrate 20. At least one haptic actuator 24 may be coupled to the processor 22 through one or more electrical conductors 28, which as discussed above, may be fixed, coiled in length or embedded within the facemask 12. In the configuration shown in FIG. 6 haptic actuator 24a and haptic actuator 24b are each extend away from the substrate 20 on a single side of the substrate 20. As discussed above with respect to the configuration shown in FIG. 5, such a configuration allows the at least one haptic actuator 24 to impart tactile outputs onto a single side of the face. However, in the configuration of FIG. 6, haptic actuator 24a and haptic actuator 24b may be positioned at different locations on the facemask 12, for example, on the chin area 30 and on the cheek area 36, or on the sides of the chin area 30. One of the at least one haptic actuators 24 may be spooled with the conductor 28 while the other is fixed at a predetermined distance away from the substrate 20, both may be coiled, or both may be fixed at a predetermined distance away from the substrate 20. Similarly, one or more of the at least one haptic actuators 24 may be slidingly electrically connected to a conductor 28 embedded within the facemask 12.

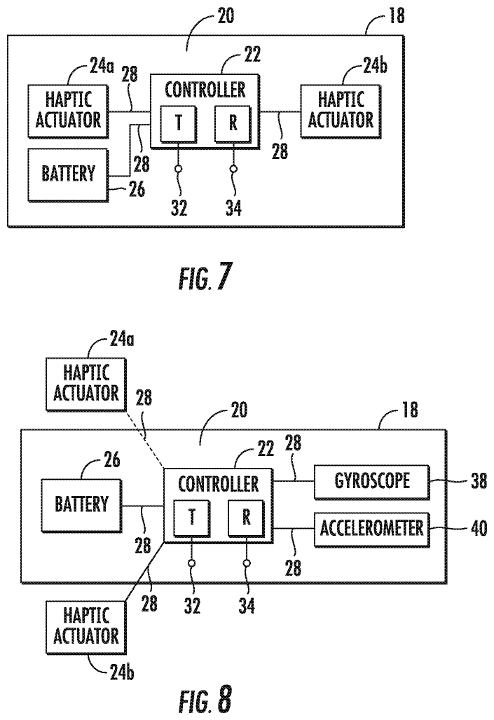

Referring now to FIG. 7, in another configuration of the haptic device 18, haptic actuator 24a is disposed on one side of the processor 22 and haptic actuator 24b is disposed on the opposite side. In such a configuration, each haptic device 20 may receive a tactile signal from the processor 22, which causes at least one of haptic actuator 24a and haptic actuator 24b to impart a tactile signal onto the facemask 12. The processor 20 may include transmitter 32 and receiver 34 and a battery as the power source 26. The tactile signal may a vibration of a programmed pre-determined duration, for example, a pulsed vibration or a series of pulses. Alternatively, the tactile signal may be any force or motion imparted on the facemask 12. The user may perceive the imparted tactile output and correlate that output to a communicated course of action, as discussed in more detail below. In such a configuration, the guidance and directional information may be communicated to the user of the facemask. For example, a vibrating pulse imparted from haptic actuator 24a or haptic actuator 24b may indicate to the user that he should proceed in the direction corresponding to the side of the face that received the tactile output. In some embodiments, a series of pulses could indicate distance to be traveled. For example, a first pulse having a first duration may indicate direction, for example, turning left. A second series of pulses, having a second duration shorter or longer than the first duration, may indicate distance, for example, each pulse train may be correlated to a predetermined distance such as five meters, such that three pulse trains may be correlated to 15 meters. A long pulse can be used to get the user's attention or to signal some other event. Put simply, the pattern and duration of pulses can be used to communicate any type of information to the user.

Referring now to FIG. 8, in another configuration of the haptic device 18, the at least one haptic actuator 24 may be configured and positioned in the same manner as the configurations described in FIGS. 5-7. In this configuration, however, the haptic device 18 also includes a gyroscope 38 and/or an accelerometer 40, which may be coupled to the power supply 26 and/or the processor 22. The gyroscope 38 may measure orientation and rotation of the substrate 20, and thus that of the user of the facemask 12. The accelerometer 40, which may also include a global positioning system (GPS) receiver, may be used to measure the acceleration and position of the substrate 20 and thus that of the user of the facemask 12. The acceleration information may be used, for example, to determine whether the user has fallen down, jumped, etc. The measurements made by the gyroscope 38 and/or the accelerometer 40 may be processed and correlated by the processor 22 to measure not only the direction or travel/position of the user of the facemask 12, but his/her orientation in space. In some embodiments, the orientation and direction of travel/position of the user may be transmitted by transmitter 32. In some embodiments, a conductor 28 electrically couples the power source 26 to the controller 22 and/or the gyroscope 28 and/or accelerometer 40. In some embodiments, a conductor 28 electrically couples other elements, e.g., the controller 22 to the gyroscope 28 and/or accelerometer 40.

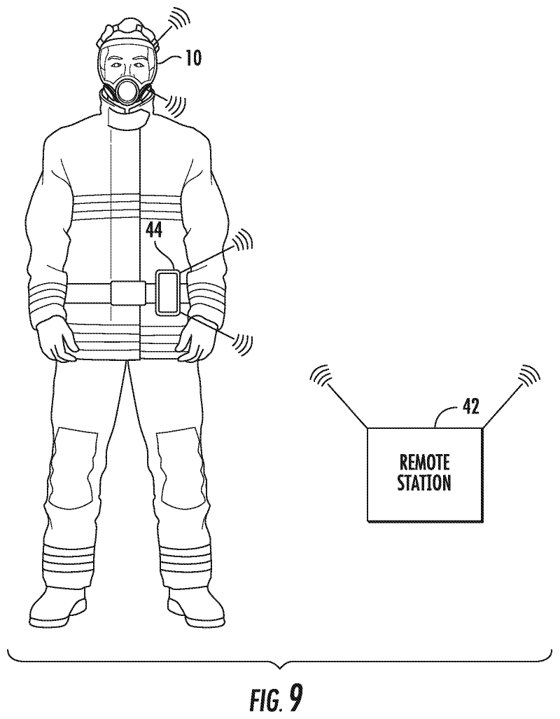

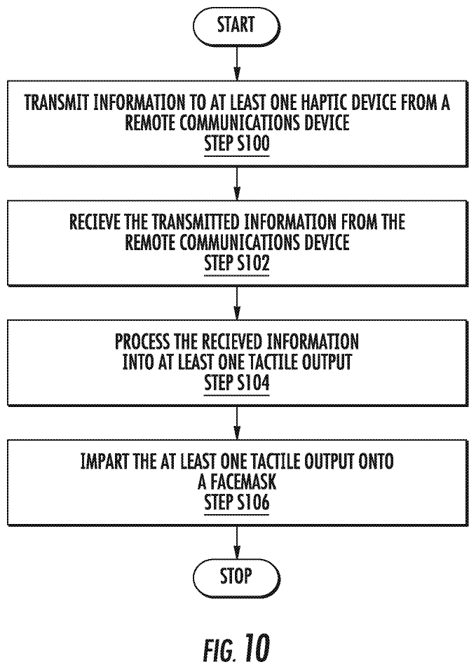

Referring now to FIG. 9, the position/direction or travel information may be paired with the orientation information and transmitted by the transmitter 32 to a remote communications device 42 either directly from the haptic device 18 or through an intermediary device on the user of the of the respirator 10, such as a Smartphone 44. Software within the remote communications device 42 or the Smartphone 44 may they process the information received from the haptic device 18 to monitor at least one of the user of the haptic device's 18 position, orientation, and movement in real-time. In other configurations, the haptic device 18 may transmit an emergency request for assistance, either manually or automatically.

For example, should the measured orientation of the user be determined to be a predetermined position requiring emergency assistance, for example supine with the ground, the transmitter 32 may be configured to automatically transmit a request for emergency assistance. Optionally, the user of the respirator 10 may manually trigger the transmission of a request for assistance, or conversely, a signal indicating a positive status, by touching a predetermined portion of the haptic device 18 or by speaking a command into the haptic device 18. In such configurations, the haptic device 18 may include a microphone (not shown) or a touch sensor (not shown) in communication with the processor 22.

An exemplary method of communicating with a user of the respirator 10 is described with reference to FIG. 10. The user of the respirator 10, which may be a firefighter, other first responder in IDLH situations, or any person in which oral communication and visibility may be difficult or limited, may seal or otherwise affix the facemask 12 to his face. The facemask 12 includes the at least one haptic device 18 discussed above. Information may be transmitted from the remote communications device 42 to the haptic device 18. (Step S100). The remote communications device 42 may be any communications devices, for example a computer, Smartphone 44, tablet computer, and the like which can send and/or receive instructions to and from the at least one haptic device 18. For example, the remote communications device 42 may send instructions and information including for example, guidance and/or direction information, ambient environment conditions, and/or a communications attempt with the user of the respirator 10, to the receiver 34 of the at least one haptic device 18 (Step S102.) The received instructions and/or information may then be processed by the processor 22 to drive the haptic actuator(s) 24 to provide one or more tactile outputs (Step S104).

For example, the instructions transmitted from the remote communications device 42 may include direction in formation, for example, “turn left,” and guidance information, for example, “walk 15 meters,” ambient conditions, for example “too much smoke or heat,” or a communication attempt, for example, “trying to make verbal contact with you.” The processor 22 may then process the received signals into one or more predetermined actuator driving signals to be transmitted or otherwise relayed to the at least one haptic actuator 24. The actuator driving signals may then cause the at least one haptic actuator 24 to impart a tactile output onto the facemask 12 (Step 106). As discussed above, the tactile outputs may include vibrations or other pulses that the user may perceive and take action based on the instructions or information. The tactile outputs may be any sequence or any duration and may be programmed into the processor 22. Optionally, the user of the respirator 10 and even the respirator 10 itself (via the processor 22 and transmitter 32) may initiate a request for assistance or other information to be transmitted to the remote communications device 42 by the methods discussed above.

Of note, the haptic device 18 may be configured such that a data packet received from the remote communications device 42 or other instructing device may an encoded and predetermined message type. When received, the processor 22 is programmed to decode the data packet into the actual pulse pattern to be provided to the haptic actuators 24. For example, in but one embodiment, message type 1 may decode to indicate that the next message should be provided to the left side haptic actuator 24, e.g., 20a, and message type 2 may decode to indicate that the next message should be provided to the right side haptic actuator, e.g., 24b. Message type 3 may decode to a long pulse, while message type 4 may decode to a short pulse. Additional message types may decode to predetermined patterns of a series of pulses and may also indicate which haptic actuators 24 should be energized. The decoding patterns may be stored in a memory that is included as part of the processor 22 or as a separate element of the haptic device 18.

Further, the haptic device 18 may be programmed to cause the transmitter 32 to transmit data packets to the remote communications device 42 indicating successful or unsuccessful receipt of a data packet from the remote communications device. The location/direction of travel and acceleration data may be encoded and formed into messages for transmission to the remote communications device 42. Any suitable communications protocol and technology may be used for communication with the remote communications device 42. For example, TCP/IP may be used for the data communication and Bluetooth may be used to communicate with the remote communications device 42 in the case where the remote communications device 42 is a Smartphone, tablet, or other computing device carried by the user. In the case where a remote data center servers as the remote communications device 42, WiFi, WiMax or cellular technologies, e.g., Long Term Evolution (LTE) may be used in addition to or in lieu of traditional long/medium range wireless communication technologies.

Although embodiments described herein show certain elements as separate physical elements, the invention is limited solely to such an arrangement. For example, although the processor 22, receiver 34 and optional transmitter 32 are shown as separate devices, it is understood that one or more of these elements may be implemented as a single physical device.

In one embodiment, a respirator 10 includes a facemask 12 and at least one haptic device 18 disposed on the facemask 12. The at least one haptic device is configured to provide tactile stimulation to at least a portion of the facemask. In one aspect of this embodiment the facemask 12 is a half mask 16 sized to fit over a user's mouth and nose, and the at least one haptic device 18 includes two haptic actuators in which the two haptic actuators are disposed on opposite sides of the half mask. In another aspect, the facemask is a full mask sized to be pressed against a perimeter of a user's face and the at least one haptic device 18 includes two haptic actuators 24. The two haptic actuators are disposed on opposite sides of the full mask.

In accordance with another aspect of this embodiment, the at least one haptic device 18 includes at least one haptic actuator 24, a receiver 34 and a processor 22. The at least one haptic actuator 24 is configured to provide tactile stimulation to at least the portion of the facemask 12. The receiver 34 is configured to wirelessly receive information from a remote communications device. The processor 22 is in communication with the receiver 34. The processor 22 is configured to process the received information to create an actuator driving signal for a determined at least one of the at least one haptic actuators 24 and transmit the at least one actuator driving signal to the determined at one haptic actuator 24. In accordance with still another aspect of this embodiment, the received information includes at least one of guidance information, a change in ambient conditions, and a verbal communication attempt. In accordance with another aspect of this embodiment, wherein the tactile stimulation includes at least one vibration. In accordance with another aspect of this embodiment, the at least one haptic device 18 further includes a transmitter 32 configured to wirelessly transmit information of at least one of a position and orientation of the facemask 12 and an emergency request for assistance. In accordance with another aspect of this embodiment, the at least one haptic device 18 further includes at least one of an accelerometer 40 and a gyroscope 38.

In accordance with another aspect of this embodiment, the at least one haptic device 18 is permanently retained within the facemask 12. In accordance with another aspect of this embodiment, the at least one haptic device 18 is releasably retained within the facemask 12.

Another embodiment provides a method of communicating with a user.

Information is transmitted to at least one haptic device 18 from a remote communications device, the at least one haptic device 18 being sized to be retained within a facemask 12 of a respirator 10, the at least one haptic device 18 being configured to receive the transmitted information from the remote communications device and process the information into at least one tactile output (Block S100). The tactile output is imparted onto the facemask 12 (Block S106).

In accordance with another aspect of this embodiment, the transmitted information from the remote communication device includes at least one of guidance information, a change in ambient conditions, and a verbal communication attempt. In accordance with another aspect of this embodiment, the at least one haptic device 18 is further configured to transmit at least one of user position and orientation information to the remote communications device, and the method further includes receiving the user position and orientation information transmitted from the at least one haptic device 18.

In accordance with another aspect of this embodiment, the facemask 12 is a half mask 16 sized to fit over the user's mouth and nose, and wherein the at least one haptic device 18 includes two haptic actuators (24), and wherein the two haptic actuators 24 are disposed on opposite sides of the half mask 16. In accordance with another aspect of this embodiment, the facemask 12 is a full mask 14 sized to be pressed against a perimeter of the user's face, and the at least one haptic device 18 includes two haptic actuators 24, and the two haptic actuators 24 are disposed on opposite sides of the full mask 14.

In accordance with another aspect of this embodiment, the at least one haptic device 18 includes at least one of an accelerometer 40 and a gyroscope 38. In accordance with another aspect of this embodiment, the at least one haptic device 18 is permanently retained within the facemask 12. In accordance with another aspect of this embodiment, the at least one haptic device 18 is releasably retained within the facemask 12. In accordance with another aspect of this embodiment, the at least one tactile signal includes at least one vibrating pulse.

Another embodiment provides a communication system, having at least one haptic device 18 sized to be releasably retained within a facemask 12 of a respirator 10. The at least one haptic device 18 is configured to be in wireless communication with and receive information from a remote communications device. The at least one haptic device 18 includes a processor 22 configured to process the information received from the remote communications device into one or more tactile signals imparted by the at least one haptic device 18 on to the facemask 12 when the respirator is worn. The at least one haptic device 18 is further configured to transmit information to the remote communications device.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A respirator, comprising:
a facemask; and
at least one haptic device disposed on the facemask, the at least one haptic device configured to provide tactile stimulation to at least a portion of the facemask.

2. The respirator of claim 1, wherein the facemask is a half mask sized to fit over a user's mouth and nose, and wherein the at least one haptic device includes two haptic actuators, and wherein the two haptic actuators are disposed on opposite sides of the half mask.

3. The respirator of claim 1, wherein the facemask is a full mask sized to be pressed against a perimeter of a user's face, and wherein the at least one haptic device includes two haptic actuators, and wherein the two haptic actuators are disposed on opposite sides of the full mask.

4. The respirator of claim 1, wherein the at least one haptic device includes:
at least one haptic actuator, the at least one haptic actuator configured to provide tactile stimulation to at least the portion of the facemask;
a receiver configured to wirelessly receive information from a remote communications device; and
a processor in communication with the receiver, the processor being configured to:
process the received information to create an actuator driving signal for a determined at least one of the at least one haptic actuators; and
transmit the at least one actuator driving signal to the determined at one haptic actuator.

5. The respirator of claim 4, wherein the received information includes at least one of guidance information, a change in ambient conditions, and a verbal communication attempt.

6. The respirator of claim 5, wherein the tactile stimulation includes at least one vibration.

7. The respirator of claim 6, wherein the at least one haptic device further includes a transmitter configured to wirelessly transmit information of at least one of a position and orientation of the facemask and an emergency request for assistance.

8. The respirator of claim 7, wherein the at least one haptic device further includes at least one of an accelerometer and a gyroscope.

9. The respirator of claim 1, wherein the at least one haptic device is permanently retained within the facemask.

10. The respirator of claim 1, wherein the at least one haptic device is releasably retained within the facemask.

11. A method of communicating with a user, the method comprising: transmitting information to at least one haptic device from a remote communications device, the at least one haptic device being sized to be retained within a facemask of a respirator the at least one haptic device being configured to receive the transmitted information from the remote communications device and process the information into at least one tactile output; and
imparting the tactile output onto the facemask.

12. The method of claim 11, wherein the transmitted information from the remote communication device includes at least one of guidance information, a change in ambient conditions, and a verbal communication attempt.

13. The method of claim 12, wherein the at least one haptic device is further configured to transmit at least one of user position and orientation information to the remote communications device, and wherein the method further includes receiving the user position and orientation information transmitted from the at least one haptic device.

14. The method of claim 11, wherein the facemask is a half mask sized to fit over the user's mouth and nose, and wherein the at least one haptic device includes two haptic actuators, and wherein the two haptic actuators are disposed on opposite sides of the half mask.

15. The method of claim 11, wherein the facemask is a full mask sized to be pressed against a perimeter of the user's face, and wherein the at least one haptic device includes two haptic actuators, and wherein the two haptic actuators are disposed on opposite sides of the full mask.

16. The method of claim 11, wherein the at least one haptic device includes at least one of an accelerometer and a gyroscope.

17. The method of claim 11, wherein the at least one haptic device is permanently retained within the facemask.

18. The method of claim 11, wherein the at least one haptic device is releasably retained within the facemask.

19. The method of claim 11, wherein the at least one tactile signal includes at least one vibrating pulse.

20. A communication system, comprising:
at least one haptic device sized to be releasably retained within a facemask of a respirator the at least one haptic device being configured to be in wireless communication with and receive information from a remote communications device;
the at least one haptic device including a processor configured to process the information received from the remote communications device into one or more tactile signals imparted by the at least one haptic device on to the facemask when the respirator is worn; and
the at least one haptic device being further configured to transmit information to the remote communications device.
